(19) United States
(12) Patent Application Publication
(10) Pub. No.: US 2004/0158740 A1
(43) Pub. Date: Aug. 12, 2004

(54) Identification card production

(75) Inventors: Brent D. Lien, Minneapolis, MN (US); Andy Vander Woude, Eden Prairie, MN (US)

Correspondence Address: Brian D. Kaul, Westman, Champlin & Kelly, 900 Second Avenue South, Suite 1600, Minneapolis, MN, 55402-3319, US

(73) Assignee: Fargo Electronics, Inc., Eden Prairie, MN (US)

(21) Appl. No.: 10/772,212

(22) Filed: Feb. 4, 2004

Related U.S. Application Data
(60) Provisional application No. 60/444,706, filed on Feb. 4, 2003.

(51) Int. Cl. H04L 9/32

(52) U.S. Cl. 713/200; 713/176

(57) ABSTRACT

In a method of producing an identification card, an identification card having identification (ID) information is scanned to thereby generate ID data that represents the ID information. Next, the ID information is retrieved from the ID data. Finally, an identification card print job defining an image that includes the retrieved ID information arranged in accordance with a template is formed.

The present application claims the benefit of U.S. provisional patent application Serial No. 60/444,706, filed Feb. 4, 2003.

### FIELD OF THE INVENTION

The present invention generally relates to a system and method for producing an identification card. More particularly, the present invention relates to a system and method of conveniently and efficiently producing an identification card for a subject using an existing identification card of the subject.

### BACKGROUND OF THE INVENTION

Identification cards are widely used to carry information relating to the cardholder. Identification cards are used for many purposes, such as employee badges, visitor badges, etc.

Identification card manufacturing systems generally include a digital camera, a computer, and an identification card printer. The digital camera is used to capture an image of a subject. A card producing application, running on the computer, is used to combine the captured image along with identification information relating to the subject to form an identification card print job. The identification information is manually entered by an operator of the system. The identification card print job defines an image containing the photo and the identification information. The print job can be processed by an identification card printer, such as those produced by Fargo Electronics, Inc. of Eden Prairie, Minn., to print the image on to a card substrate and form the desired identification card for the subject.

The production of identification cards using such systems can be inefficient and inconvenient for the subjects of the identification cards. For instance, each of the subjects seeking an identification card must be available to have his or her photo taken as well as to provide the required identification information. Additionally, each subject must wait for his or her identification information to be manually entered prior to having the resulting print job processed by the identification card printer. Furthermore, the production of identification cards using such systems becomes very time consuming especially when multiple subjects are seeking identification cards. In such instances, each subject is forced to wait for the preceding subject to complete the process before they can begin the process themselves. Accordingly, the subjects may encounter a significant delay before obtaining an identification card.

### SUMMARY OF THE INVENTION

The present invention is generally directed to a method and system for conveniently and efficiently producing an identification card. In the method, an identification card having identification (ID) information is scanned to thereby generate ID data that represents the ID information. Next, the ID information is retrieved from the ID data. Finally, an identification card print job defining an image that includes the retrieved ID information arranged in accordance with a template is formed. The identification card print job can then be processed by an identification card printer by printing the image on a card substrate.

The system of the present invention generally includes a scanner, a scanning application, and an ID card producing application. The scanning application is configured to control the scanner to scan an identification card having ID information and thereby generate ID data representing the ID information. The ID card producing application is configured to retrieve the ID information from the ID data and form an identification card print job defining an image that includes the retrieved ID information that is arranged in accordance with a template. The system can also include an identification card printer that is configured to process the identification card print job by printing an image to a card substrate.

Other features and benefits that characterize embodiments of the present invention will be apparent upon reading the following detailed description and review of the associated drawings.

### BRIEF DESCRIPTION OF THE DRAWINGS

FIG. 1 is a flowchart illustrating a method of producing an identification card in accordance with embodiments of the invention.

FIGS. 2A and 2B respectively show front and rear views of an exemplary identification card.

FIG. 3 is a schematic diagram of a system for producing an identification card in accordance with embodiments of the invention.

FIG. 4 is a schematic diagram of an exemplary template in accordance with embodiments of the invention.

FIG. 5 is a schematic illustration of an identification card in accordance with embodiments of the invention.

### DETAILED DESCRIPTION OF THE PREFERRED EMBODIMENTS

The present invention relates to a method for producing an identification card and a system that is configured to perform the method.

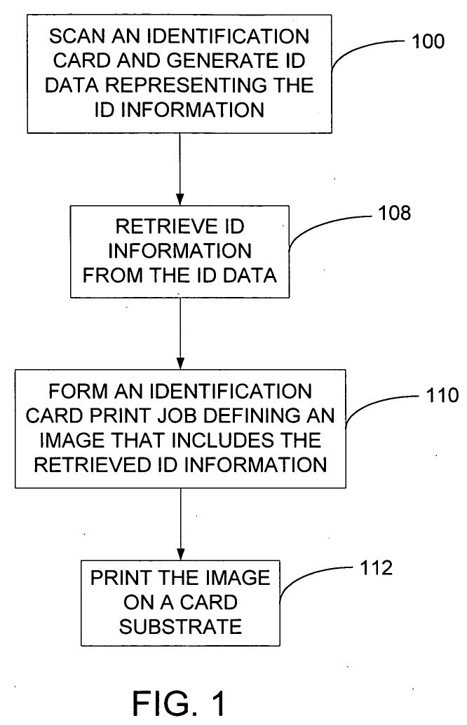

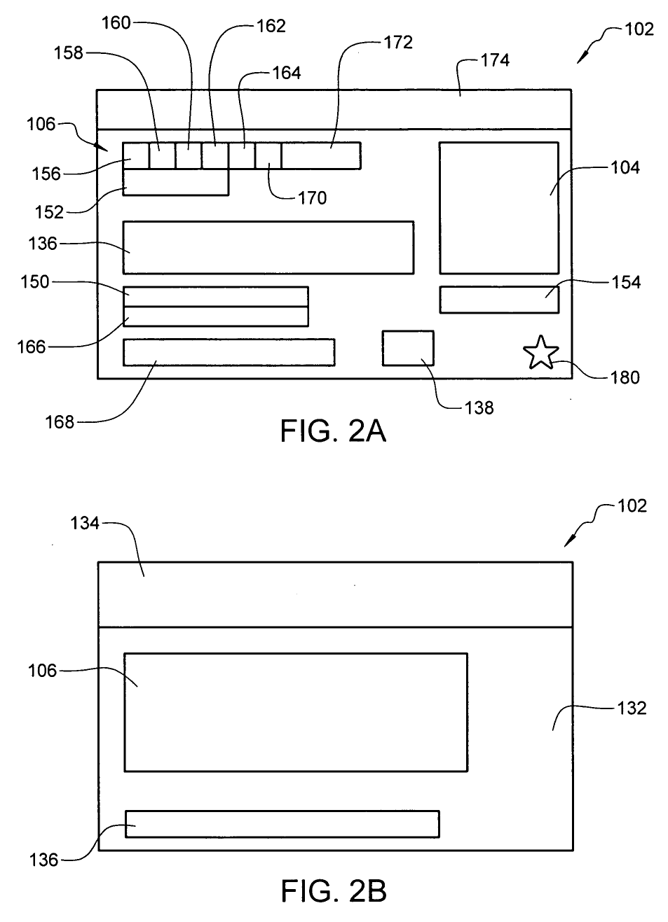

FIG. 1 is a flowchart illustrating steps of the method in accordance with embodiments of the invention. At step 100, an identification card having ID information is scanned and ID data representing the ID information is generated. The identification card of the subject, for which a new identification card is to be produced, is preferably a photo identification card, an example of which is illustrated schematically in FIGS. 2A (front view) and 2B (rear view). Identification card 102 generally contains ID information about the subject, such as a photo 104 of the subject, textual ID information 106 about the subject and non-textual information, as will be explained in greater detail below.

At step 108 of the method, the ID information represented by the ID data is retrieved. The retrieved ID data generally includes select elements of the identification information contained on the identification card 102 including, for example, photo 104 and various textual ID information elements 106. Finally, at step 110, an identification card print job is formed. The identification card print job defines an image that includes the retrieved ID information that is preferably arranged in accordance with a template. In accordance with one embodiment of the invention, the image is printed to a card substrate to form an identification card for the subject, at step 112 of the method.

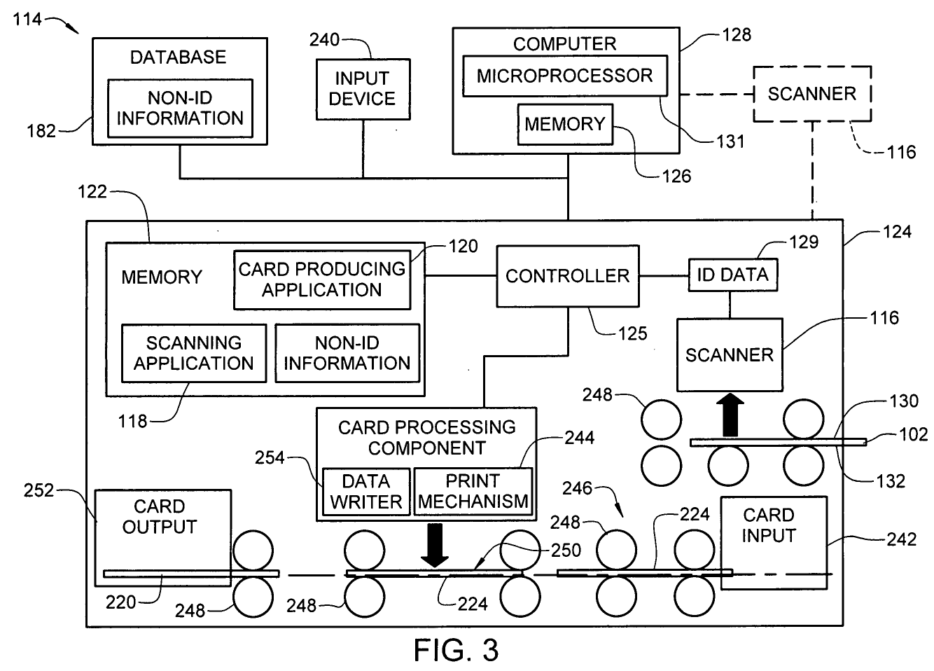

An exemplary system 114 that is configured to perform the method of the present invention is illustrated schematically in FIG. 3. System 114 generally includes a scanner 116, a scanning application 118, and an ID card producing application 120.

The scanning application 118 can reside in memory 122 an identification card printer 124 and be executed by controller 125, or in memory 126 of a computer 128 can be executed by microprocessor 131. Scanning application 118 is generally configured to control scanner 116 to scan the existing identification card 102 of the subject that includes the ID information and thereby generate ID data 129 representing the ID information, as described in step 100 of the method of FIG. 1. Card scanning application 118 is preferably configured to use Optical Character Recognition (OCR) to determine the alphanumeric characters of the textual ID information 106, which are then represented in the ID data 129. ID data 129 can also represent other types of information, as will be explained below in greater detail.

Scanner 116 can be a component of identification card printer 124, or formed separate therefrom as indicated in the dashed box. Scanner 116 is preferably an optical scanner that is configured to capture an image of a surface, such as front surface 130 (FIG. 2A) and/or rear surface 132 (FIG. 2B), of the identification card 102. Scanner 116 can also include a data reader that is configured to extract information from a magnetic stripe 134 (FIG. 2B), a barcode 136 (FIGS. 2A and 2B), and/or a memory chip 138 of identification card 102.

As mentioned above, identification card 102 of the subject, for which a new identification card is to be produced, is preferably a photo identification card, such as a state-issued driver's license, or other type of identification card, that includes the subject's photo 104 and textual ID information 106 about the subject. However, identification cards 102 having only textual ID information 106 can be used as well.

The textual ID information 106 can include various textual ID information elements relating to the subject such as, for example, the subject's name 150, birth date 152, license number 154 (e.g., driver's license number), eye color 156, height 158, weight 160, sex 162, driver's license class 164, address 166, signature 168, and other information relating to the subject. Labels for the textual ID information elements 106 and other elements of card 102 can be provided on card 102, but are not shown in order to simplify the illustration. The textual ID information elements 106 can also include information about the identification card 102, such as issuance information 170, an expiration and/or issue date 172, the state that issued the card 174, and other information.

Identification card 102 can also include non-textual information (data) stored in barcode 136 (FIGS. 2A and 2B), magnetic stripe 134 (FIG. 2B), a memory chip 138 (smart card chip), or stored on card 102 in another manner. The non-textual information and other data can also be embedded within a watermark on card 102. A watermark is generally an image within an image, such as an image within photo 104 or located elsewhere on card 102, which is preferably undetectable to the naked eye. Such watermarks can be used to authenticate the identification card 102. The data embedded within the watermark can be extracted therefrom in accordance with conventional methods.

The non-textual ID information can include data that represents the textual ID information 106 on card 102, the photo 104, and other information. For example, the non-textual ID information can provide information as to the format of the card 102, which can be used to locate the photo 104, textual ID information elements 106, and other information on card 102. The format can also be determined based upon other markings on card 102. For example, card 102 can include a reference mark 180, shown in FIG. 2A, from which the locations of various ID information elements on the card 102 can be determined based upon the provided card format. The format of the card 102 as well as other non-textual ID information contained on card 102 can also be used by the system 114 of the present invention to verify the validity of identification card 102 prior to the processing of it to form a new identification card for the subject.

ID card producing application 120 is generally configured to retrieve the ID information from the ID data 129 (FIG. 3) that is generated in response to the scanning of card 102, and form an identification card print job. The identification card print job defines an image that includes the retrieved ID information arranged in accordance with a template. Accordingly, card producing application 120 is generally configured to perform steps 108 and 110 of the method illustrated in FIG. 1. As with the card scanning application 118, the ID card producing application 120 can reside in memory 122 of printer 124 or in memory 126 of computer 128.

The retrieval of the ID information from the ID data 129 is preferably based upon the format of the card 102 that is contained in the ID data 129. The identified format can be matched to various formats contained in a remote database 182, in memory 122 of printer 124, or in memory 126 of computer 128. Once the format for the card 102 is identified, the format can be used to automatically locate and select the desired elements of the ID information contained on card 102 including the photo 104, and textual ID information elements 106, as well as non-textual information elements contained, for example, in barcode 136 and magnetic stripe 134, for insertion into the template. Alternatively, the ID information elements can be automatically identified through an analysis of the ID data 129 by the scanning application 118 or by the card producing application 120. For example, the desired textual ID information elements 106 can be identified using conventional optical character recognition methods. Furthermore, many identification cards 102, particularly state-issued driver's licenses, frame the various ID information elements including the photo 104 and the textual ID information elements 106 with a distinctive border. Such a border can be identified by the scanning application 118 and used to detect the locations of the ID information elements, especially when a format for the card 102 is known.

In accordance with another embodiment of the invention, the user of system 114 can select individual ID information elements from the ID data 129 generated by the scanning of the card 102 for insertion into the template. For example, the user of the system 114 can select the photo 104 and individual textual ID information elements 106, such as the subject's name 150, from the ID data 129 that is presented to the user as a scanned image of card 102. Preferably, the ID information elements are automatically identified by the scanning application 118 and are presented to the user as distinct and highlighted elements. The user can then drag and drop the selected elements into the corresponding locations of the template. Although such a procedure is more time consuming than the automated procedure described above, it is still much quicker and more efficient than the alternative of manually entering the subject's ID information into the template.

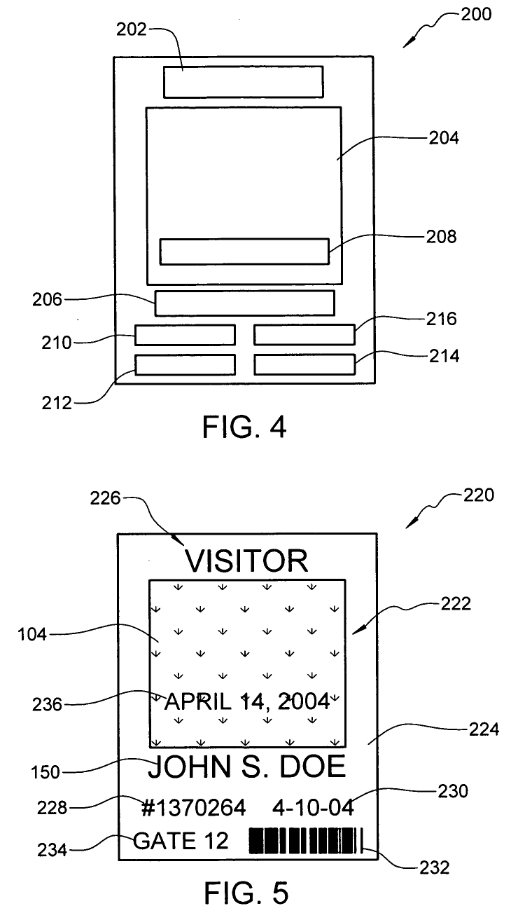

An exemplary template 200 is provided in the schematic diagram of FIG. 4. In general, template 200 defines a form for the identification card that is to be produced for the subject by designating the ID information extracted from the ID data 129 that was produced in response to the scanning of identification card 102. Additionally, template 200 can designate non-ID information that may or may not have been extracted from the scanned identification card 102. The non-ID information can include the current time and date, the location where the card was issued, a name of a person who is issuing the identification card, a list of appointment information, an expiration date for the card, a color code, a security code or mark, and other information. The appointment information can include, for example, the time and place of the appointment or meeting and a person with whom the appointment is scheduled with. The color code can be an indicator of a security clearance level that is being issued with the card and/or be an indicator of the card's validity. For example, valid cards for a certain day or week may have a certain color. The security code or mark can be a bar code that includes information that can be extracted with a suitable scanner, a hologram, or other security mark that can be used to validate the card that is produced by system 114 or make it more difficult to counterfeit or tamper with.

Template 200 also defines a location for select ID and non-ID information elements that were retrieved from the ID data generated in response to the scanning of card 102. For example, template 200 can designate various ID and non-ID information locations such as a subject identifier location 202, a photo location 204, a name location 206, a security mark location 208, an ID number location 210, an access code location 212, a barcode location 214, and a date location 216. The template 200 also preferably designates a format for each of the elements contained therein. For example, the template can set the font, size, and color of the text that is used at each location, the size of the photo, and other formatting options.

The layout of the ID and non-ID information in the template 200 is preferably different from that of the identification card 102 that was scanned to produce the ID data. Accordingly, the locations of the ID information within the image that will be produced in accordance with the template 200 are generally different from the locations of the corresponding ID information on the scanned ID card 102. Additionally, the format of the ID information that is presented in the image can be different from the original presentation of the information on identification card 102.

FIG. 5 is a schematic illustration of an identification card 220 produced by system 114 that includes an image 222 that has been printed to a card substrate 224. Image 222 is formed in accordance with template 200 and includes selected ID and non-ID information that is presented in accordance with the exemplary template 200 of FIG. 4. Accordingly, image 222 includes ID information that was contained on identification card 102 including the subject's name 150 in the name location 206, the photo 104 of the subject in the photo location 204. Image 222 also includes non-ID information such as, a subject identifier 226 (i.e., “VISITOR”) in the subject identifier location 202, an ID number 228 in the ID number location 210, an issue date 230 of identification card 220 in the date location 216, a barcode 232 containing information about the subject of identification card 220 and/or security information in barcode location 214, an access location 234 in the access gate location 212, and a security mark 236 provided in the security mark location 208. Security mark 236 can be in the form of an expiration date for the identification card 220, or a watermark that is formed within the image 222, such as within the photo 104, portion of image 222, for example.

The ID and non-ID information can also be entered by an operator of the system 114 using an appropriate input device 240 (e.g., a keyboard), retrieved from database 182, stored in memory 122 of printer 124, memory 126 of computer 128, or retrieved form another location. This is particularly useful for entering textual and graphical elements into template 200 that are not contained in the ID data 129.

As mentioned above, the presentation of the ID information can be augmented relative to the scanned ID card 102 such that it does not match the identification card 102. For example, the photo 104 in image 222 is preferably augmented or modified as compared to the original photo 104 on the identification card 102 by changing its size and/or image settings (color, contrast, etc.). Similarly, the size and font of the textual ID information, such as the subject's name 150, is preferably modified relative to that presented in the original card 102 to make the information in the image 222 more visible for easy inspection of the new identification card 220, for example.

After the ID information (i.e., photo 104 and textual ID information 106) and/or non-ID information have been entered into the template 200, an identification card print job is generated by the card producing application 120. In accordance with one embodiment of the invention, the identification card print job is delivered to the controller 125 of identification card printer 124, which processes the identification card print job through the control of the printer components to print the image 222 defined by the identification card print job onto the card substrate 224.

In general, an individual card substrate 224 is fed from a card input 242 (i.e., card hopper) to a print mechanism 244 by a card feed mechanism 246. The card feed mechanism 246 can include, for example, conventional card feeding components such as feed and guide rollers 248 that are driven by a motor (not shown) under control of controller 125. The print mechanism 244 can be an ink jet printhead, a thermal printhead, or other suitable print mechanism that is configured to print the image 222 to surface 250 of card substrate 224, as card substrate 224 is presented to the print mechanism 244 by the card feed mechanism 246. Following the printing of the image 222 to card substrate 224, the card feed mechanism 246 discharges the new identification card 220 through a card output 252.

Data, such as the ID and non-ID information discussed above and security information that can be used to validate the identification card 220, can also be provided. In accordance with one embodiment of the invention, identification card printer 124 includes a data writer 254 that is configured to write such data to card substrate 224. For example, data writer 254 can write data to a magnetic stripe of card substrate 224, a memory chip of card substrate 224 (smart card), or other component of card substrate 224 to which data can be written. The data written to card 220 can be encrypted if desired. Additionally, image 222 printed on card substrate 224 can include a watermark, such as security mark 236, in which the data is embedded.

In operation, a subject for which an identification card is to be produced, inserts an existing identification card 102 into scanner 116. The card scanning application 118 controls scanner 116 to scan at least one surface of the card 102 such as front surface 130, as illustrated in FIG. 3. The card 102 can then be immediately ejected from the scanner 116 and returned to the subject. The card scanning application 118 produces ID data 129 that represents select ID information contained on the card 102. The ID information can include a photo 104 and/or textual ID information elements 106, as described above. The ID information is then retrieved directly from the ID data 129 and used by card producing application 120 to form an identification card print job by selectively inserting elements of the ID information into a predefined template 200 to define an image 222. Preferably, the insertion of the ID information elements into the template 200 is performed automatically by card producing application 120. The image 222 defined by the identification card print job can then be processed by identification card printer 124 by printing the image 222 on a card substrate 224 using print mechanism 224 to thereby complete the formation of a new identification card 220. The identification card 220 is then discharged from the printer 124 and provided to the subject.

Although the present invention has been described with reference to preferred embodiments, workers skilled in the art will recognize that changes may be made in form and detail without departing from the spirit and scope of the invention. For example, the card scanning application 118 in the card producing application 120 could be packaged in a single application, or their various functions could be implemented in multiple applications.

What is claimed is:

1. A method of producing an identification card comprising steps of:
a) scanning an identification card having ID information thereby generating ID data representing the ID information;
b) retrieving the ID information from the ID data; and
c) forming an identification card print job defining an image that includes the retrieved ID information arranged in accordance with a template.

2. The method of claim 1 including d) printing the image defined by the identification card print job on a card substrate.

3. The method of claim 1 including e) writing data to the card substrate.

4. The method of claim 1, wherein the image does not match the identification card.

5. The method of claim 4, wherein locations of the ID information within the image are different from locations of the ID information on the identification card.

6. The method of claim 1, wherein:
the ID information includes textual ID information and a photo; and
the image contains the photo and the textual ID information.

7. The method of claim 6, wherein the textual ID information is selected from a group consisting of a name, a birth date, a license number, a height, a weight, a sex, an eye color, an issue date, an expiration date, a class, a signature, an address, an ID number, and a state.

8. The method of claim 6, wherein the photo contained in the image is augmented relative to the photo contained in the ID information of the identification card.

9. The method of claim 6 including d) printing the image defined by the identification card print job on a card substrate.

10. The method of claim 1, wherein the image includes non-ID information that is not contained in the ID information.

11. The method of claim 10, including retrieving the non-ID information from the identification card.

12. The method of claim 11, including retrieving the non-ID information from an element of the identification card selected from a group consisting of a barcode of the identification card, a magnetic stripe of the identification card, a memory chip of the identification card, and a watermark of the identification card.

13. The method of claim 10, wherein the non-ID information includes a security mark.

14. The method of claim 13, wherein the security mark is selected from a group consisting of a date, a security code, a hologram, a barcode, and a color code.

15. The method of claim 10, wherein the non-ID information is selected from a group consisting of a date, a time, a location, a name of a card issuer, appointment information, a color code, a watermark, and a security code.

16. The method of claim 10 including a step of retrieving the non-ID information from memory.

17. The method of claim 1, wherein the retrieving step b) includes identifying a card format of the identification card and extracting the ID information from the ID data based upon the card format.

18. The method of claim 17, wherein the card format identifies locations of photo and textual ID information elements.

19. The method of claim 18, wherein the textual ID information elements are selected from a group consisting of a name, a birth date, a license number, a height, a weight, a sex, an eye color, an issue date, an expiration date, a class, a signature, an address, an ID number, and a state.

20. The method of claim 19 including manually selecting individual textual ID information elements for insertion into the template to form the identification card print job in the forming step c).

21. The method of claim 1, wherein the scanning step a) includes optically scanning a surface of the identification card.

22. The method of claim 1, wherein the scanning step a) includes reading a barcode on a surface of the identification card.

23. The method of claim 1, wherein the scanning step a) includes reading a magnetic stripe on a surface of the identification card.

24. The method of claim 1, wherein the retrieving step b) includes identifying elements of the ID information including textual ID information elements.

25. The method of claim 24, wherein the textual ID information elements are selected from a group consisting of a name, a birth date, a license number, a height, a weight, a sex, an eye color, an issue date, an expiration date, a class, a signature, an address, an ID number, and a state.

26. The method of claim 24 including a step of manually selecting individual textual ID information elements for insertion into the template to form the identification card print job in the forming step c).

27. The method of claim 1, wherein the image includes a watermark.

28. A method of producing an identification card comprising steps of:
a) scanning an identification card having ID information including textual ID information and a photo thereby generating ID data representing the ID information;
b) retrieving the textual ID information and the photo from the ID data; and
c) forming an identification card print job defining an image that includes the retrieved textual ID information and the photo arranged in accordance with a template.

29. The method of claim 28 including d) printing the image defined by the identification card print job on a card substrate.

30. The method of claim 28 including e) writing data to the card substrate.

31. The method of claim 28, wherein the image does not match the identification card.

32. The method of claim 28, wherein the textual ID information is selected from a group consisting of a name, a birth date, a license number, a height, a weight, a sex, an eye color, an issue date, an expiration date, a class, a signature, an address, an ID number, and a state.

33. The method of claim 28, wherein the photo contained in the image is augmented relative to the photo contained in the ID information of the identification card.

34. The method of claim 28 including retrieving non-ID information that is not contained in the ID information on the identification card and adding the non-ID information to the image defined by the identification card print job.

35. The method of claim 34, wherein the non-ID information is selected from a group consisting of a date, a time, a location, a name of a card issuer, appointment information, a color code, and a security code.

36. The method of claim 34, wherein the non-ID information is retrieved from memory.

37. The method of claim 28, wherein the retrieving step b) includes identifying a card format of the identification card and extracting the ID information from the ID data based upon the card format.

38. The method of claim 28, wherein the scanning step a) includes optically scanning a surface of the identification card.

39. The method of claim 28, wherein the scanning step a) includes reading a bar code on a surface of the identification card.

40. The method of claim 28, wherein the scanning step a) includes reading a magnetic stripe on a surface of the identification card.

41. A system for producing an identification card comprising:
a scanner;
a scanning application configured to control the scanner to scan an identification card having ID information and thereby generate ID data representing the ID information; and
an ID card producing application configured to retrieve the ID information from the ID data and form an identification card print job defining an image that includes the retrieved ID information arranged in accordance with a template.

42. The system of claim 41 including an identification card printer adapted to print the image defined by the identification card print job on ink card substrates.

43. The system of claim 42, wherein the scanner is formed integral with the identification card printer.

44. The system of claim 41, wherein the scanner includes an optical scanner.

45. The system of claim 41, wherein the scanner includes a magnetic stripe reader.

46. The system of claim 41, wherein the image does not match the identification card.

47. The system of claim 41, wherein:
the ID information includes textual ID information and a photo; and
the image contains the photo and the textual ID information.

48. The system of claim 47, wherein the textual ID information is selected from a group consisting of a name, a birth date, a license number, a height, a weight, a sex, an eye color, an issue date, an expiration date, a class, a signature, an address, an ID number, and a state.

49. The system of claim 47, wherein the photo contained in the image is augmented relative to the photo contained in the ID information of the identification card.

50. The system of claim 47, wherein the image includes non-ID information that is not contained in the ID information on the identification card.

51. The system of claim 50, wherein the non-ID information is selected from a group consisting of a date, a time, a location, a name of a card issuer, appointment information, a color code, and a security code.

52. The system of claim 51 including memory containing the non-ID information.
